(19) United States
(12) Patent Application Publication
(10) Pub. No.: US 2013/0342471 A1
(43) Pub. Date: Dec. 26, 2013

(54) Display with Wireless Transmission Functions

(71) Applicant: Chien-Chin Chen, Taipei (TW)

(72) Inventor: Chien-Chin Chen, Taipei (TW)

(21) Appl. No.: 13/531,382

(22) Filed: Jun. 22, 2012

(51) Int. Cl. G06F 3/041

(52) U.S. Cl. 345/173

(57) ABSTRACT

A display with wireless transmission functions for transmitting wireless signals to a first wireless transmission module of an electronic device; said display comprising: a screen, touch module and second wireless transmission module; of which, the touch module is configured on the screen; and the second wireless transmission module is mounted onto the screen and connected with the touch module, and used to receive touch signals from the touch module and transmit wireless signals to the electronic device.

### BACKGROUND OF INVENTION

1. Field of the Invention

The present invention relates to a screen, and more particularly to a display that could provide wireless transmission signals and touch functions.

2. Description of the Related Art

With fast-changing technical advancement and innovation, the consumers could live a high-quality life or work more conveniently and efficiently. However, for example, only display is provided with a touch screen, so it is only applied to specific devices such as: desktop screens or mobile products.

People rely on convenient electronic products in modern era; thus, wireless electronic signals exist everywhere, and convenient functions required for human activities are provided by mobile phones and game consoles, etc, by using technologies such as 3GPP LTE, WiMAX, WiFi and UMB of 3GPP2. However, these technologies are dependent on transmitting and receiving wireless electronic signals; hence, there is a space for improvement in the industry, enabling common window glass to provide wireless transmission signals and touch functions for a better living or office environment.

To this end, the inventor has provided the present invention of practicability after deliberate design and development based on his years of experience and know-how in the wireless transmission and touch screen sectors, so as to further improve the competitiveness and value-added applicability of the present invention.

### SUMMARY OF THE INVENTION

The purposes and advantages of the present invention will be more readily understood upon a thoughtful deliberation of the following detailed description of preferred embodiments of the present invention with reference to the accompanying drawings. Yet, some components contained therein or their configurations may vary to some extent, but the preferred embodiments are elaborated with their construction shown in the accompanying drawings.

FIG. 1 depicts a preferred embodiment of the present invention, which, however, is provided for only explanatory objective for patent claims.

The display 1 of the present invention with wireless transmission functions could receive signals transmitted by an electronic device 2; the electronic device 2 hereto is a desktop host computer, notebook computer, tablet PC, player (e.g.: DVP) or other 3C products. For instance, the first wireless transmission module 21 of the electronic device 2 contains a transmitting terminal TX211, while the display 1 comprises of a screen 11, touch module 12 and second wireless transmission module 13 as well as signal control panel 14.

Referring to FIGS. 2 and 3, the screen 11 of the present invention could be applied to the glass in living or office environment, including but not limited to any soft board, white or black board or any kind of objects attached onto wall surfaces, etc; of which Active Matrix Organic Light Emitting Display (AMOLED) technology can be used; the screen 11 of the present invention can be used on transparent materials such as: transparent windows and glass doors, while the preferred embodiment of window is set on the wall surface of a building or used on the window glass of a vehicle.

The touch module 12 is configured on the screen 11, and provided with many specific details such as: special programs, programming and components, helping to obtain an improved insight into the preferred embodiments of the present invention. However, it is understood by those skilled in the art that, the touch module 12 could be implemented without one or more specific details, or in combination with other methods and components. In other embodiments, well-known structures or operations are not shown or described in detail for avoiding confusion of the viewpoints contained therein. The screen of the touch module 12 of the present invention could be covered by an optical sensor component, which could detect and track dynamically the objects within its sensing range; it is divided into capacitance, resistance, IR optical or acoustic wave types, etc.

The second wireless transmission module 13 is mounted onto the screen 11 and connected with the touch module 12 and signal control panel 14; moreover, the second wireless transmission module 13 and signal control panel 14 can be mounted at any side of the screen 11 or on the window frame, and used to receive touch signals of the touch module 12 and transmit to the electronic device 2; the second wireless transmission module 13 of the display 1 comprises of a receiving terminal RX131 and a transmitting terminal TX211 for transmitting wireless signals to the receiving terminal RX131.

The screen 11 of the present invention (e.g.: window) has daylighting and light transmission effects, etc. However, its substrate 111 is not limited to glass, and also can be replaced by other transparent materials such as: acryl materials or reinforced plastics for the same efficacy.

The screen 11 of the present invention allows to display images and receive/transmit wireless signals from the electronic device 2; the images on the screen 11 can be used in collaboration with imaging signals from the electronic device 2.

FIG. 4 depicts wireless transmission methods of the display of the present invention, wherein the operating procedures (e.g.: notebook computer) include the following steps:

Step 110: the signal source is imaging signal from transmitting terminal TX211 of the first wireless transmission module 21 of the electronic device 2.

Step 120: the receiving terminal RX131 of the second wireless transmission module 13 of the display 1 receives imaging signals from the transmitting terminal TX211.

Step 130: the imaging signals are transmitted simultaneously to the signal control panel 14.

Step 140: the touch module 12 on the screen 11 receives touch signals.

Step 150: the touch signals at corresponding points are transmitted to the transmitting terminal TX211.

Step 160: the transmitting terminal TX211 transmits bi-directionally the touch signals to the receiving terminal RX131.

Step 170: the imaging signals of the electronic device 2 are touched at a spacing, and the images on the screen 11 are displayed simultaneously.

Said screen 11 contains a plurality of electronic components (e.g.: control chips and processor); the second wireless transmission module 13 is compatible with wireless HD video interfacing standard based on its Wireless Home Digital Interface (WHDI) technology. As per this standard, HD uncompressed wireless interfacing is made available, so video data could be transmitted through 5 GHz license-free frequency band at a rate of 3G-bps (including: 1080p/60 Hz), in line with 5 GHz international spectrum criterion. With a transmission range over 100 m and a delay less than 1 ms, the signals could penetrate the wall; the second wireless transmission module 13 could transmit wireless signals to the first wireless transmission module 21 of the electronic device 2. Specifically, the second wireless transmission module 13 (WHDI) of the display 1 is provided with a receiving terminal RX131, and the first wireless transmission module 21 of the electronic device 2 is provided with a transmitting terminal TX211, so the wireless signals could be transmitted by the transmitting terminal TX211 to the receiving terminal RX131.

In the present invention, the screen, touch module, second wireless transmission module and signal control panel are integrated modularly, such that the display has the functions of touching control or wireless TX/RX in collaboration with the electronic device; hence, it can be directly applied to windows, glass doors or soft boards in living or office environment as a bulletin or for networking, seeing a movie or playing games, etc.

To sum up, the present invention is an innovative product not yet publicly available complying with the spirit of new patents, so the patent claims are made hereto. And, the above is a detailed description of the present invention based on a typical preferred embodiment. However, it should be appreciated that all equivalent structural variations or changes relating to the description and drawings of the present invention shall be embraced within the scope of the following claims.

### BRIEF DESCRIPTION OF THE DRAWINGS

FIG. 1: a block chart of the present invention.

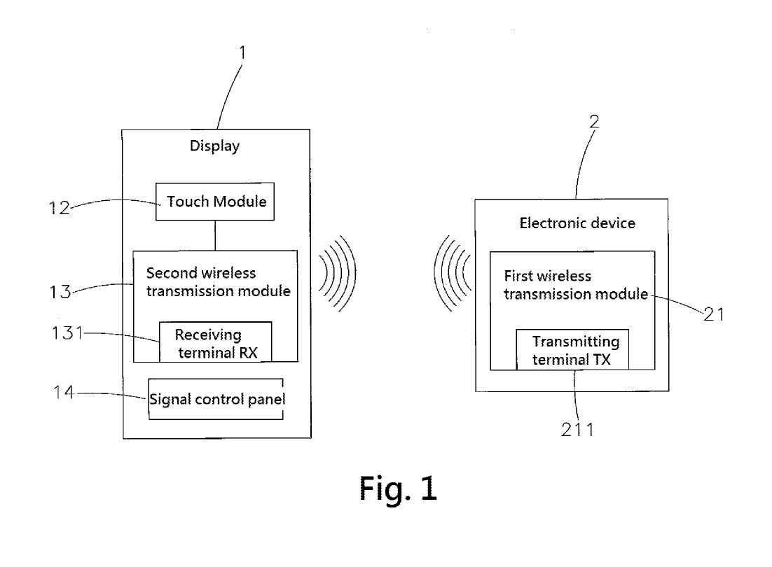

FIG. 2: a perspective view of the present invention.

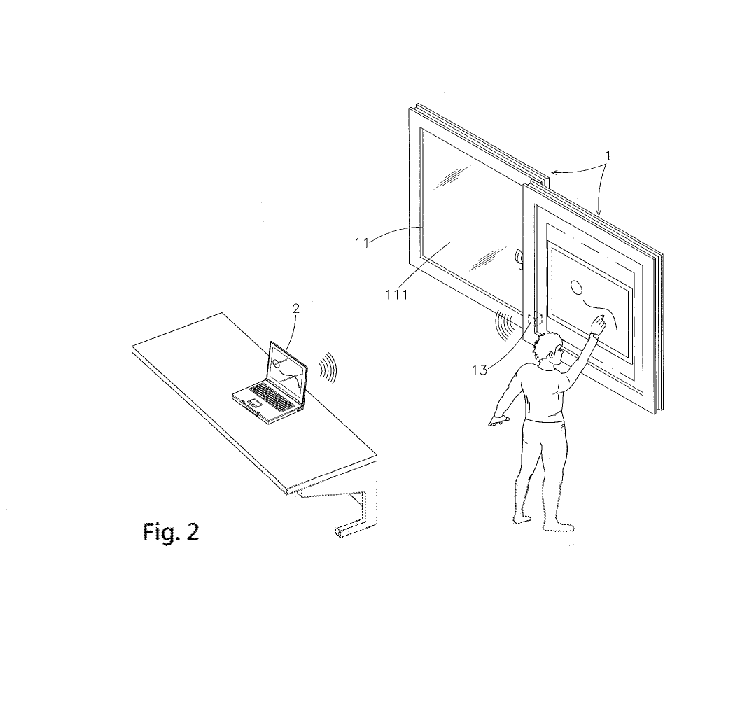

FIG. 3: an operating view of the present invention.

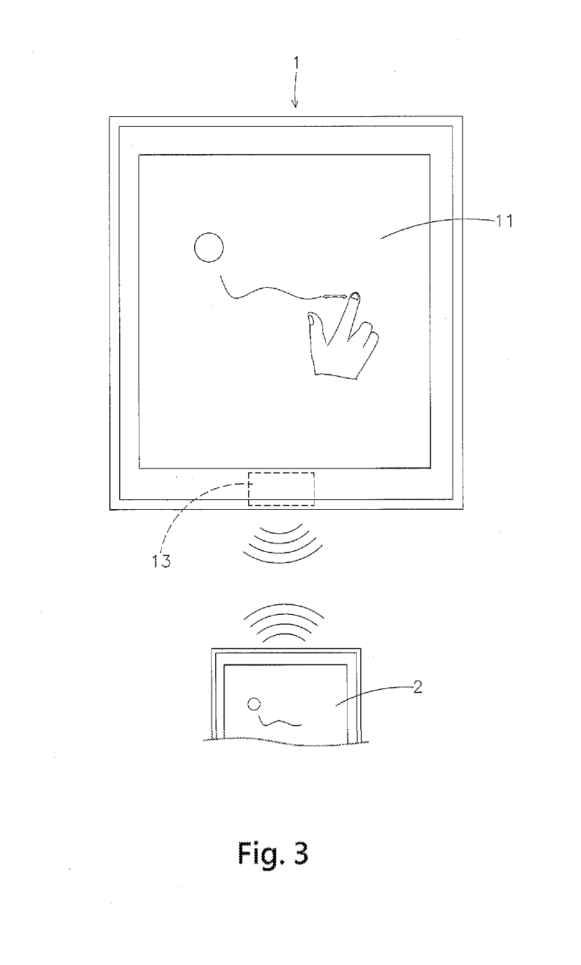

FIG. 4: a flow process chart of the present invention.

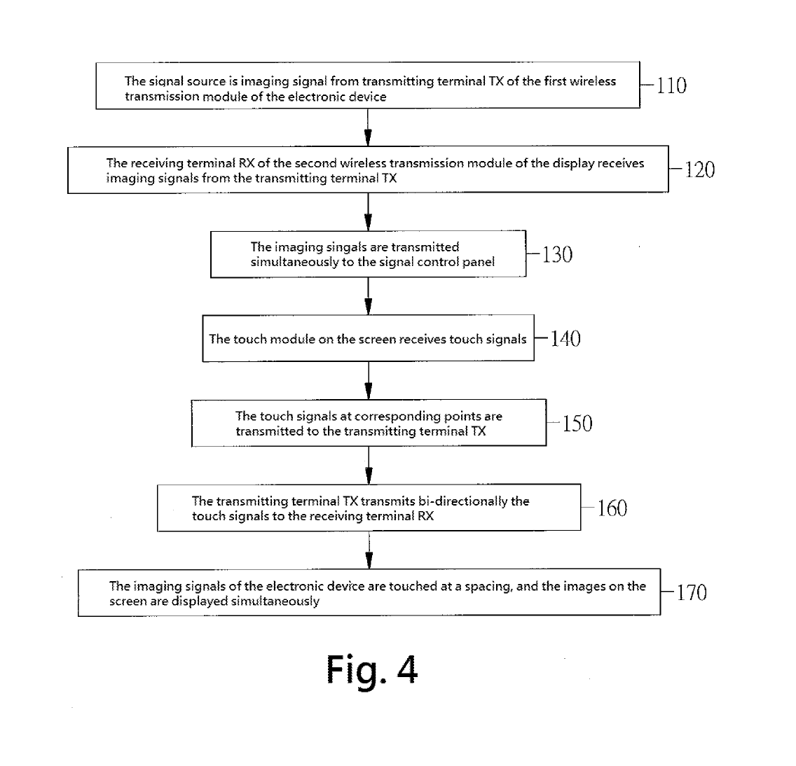

### DETAILED DESCRIPTION OF THE INVENTION

The primary objective of the present invention is to provide a display with wireless transmission functions that could transmit wireless signals to the first wireless transmission module of the electronic device; the display comprises: a screen, touch module and second wireless transmission module, of which the touch module configured on the screen, and the second wireless transmission module is mounted onto the screen and connected with the touch module, and used to receive the touch signals of the touch module and transmit wirelessly to the electronic device.

To this end, the screen, touch module, second wireless transmission module and signal control panel are integrated modularly, such that the display has the functions of touching control or wireless TX/RX in collaboration with the electronic device; hence, it can be directly applied to windows, glass doors or soft boards in living or office environment as a bulletin or for networking, seeing a movie or playing games, etc.

The features and functions of the present invention will be more readily understood by the technicians upon a thoughtful deliberation of the following detailed description of preferred embodiments of the present invention with reference to the accompanying drawings.

Although the invention has been explained in relation to its preferred embodiment, it is to be understood that many other possible modifications and variations can be made without departing from the spirit and scope of the invention as hereinafter claimed.

1. A display with wireless transmission functions for transmitting wireless signals to a first wireless transmission module of an electronic device; said display comprising:
a screen;
a touch module, configured on the screen; and
a second wireless transmission module, mounted onto the screen and connected with the touch module, and used to receive touch signals from the touch module and transmit wireless signals to the electronic device.

2. The display with wireless transmission functions as claimed in claim 1, wherein said screen contains a substrate that's made by transparent materials.

3. The display with wireless transmission functions as claimed in claim 1, wherein said first wireless transmission module of the electronic device contains a transmitting terminal.

4. The display with wireless transmission functions as claimed in claim 3, wherein the second wireless transmission module of the display comprises of a receiving terminal, to which wireless signals are transmitted by the transmitting terminal.

5. The display with wireless transmission functions as claimed in claim 1, wherein a signal control panel is connected with the second wireless transmission module and touch module.

6. A wireless transmission method for display, comprising steps:
to touch an imaging signal of a screen and trigger a touch signal at corresponding point; and transmit the touch signal to an electronic device by a wireless transmission module.
